(19) United States
(12) Patent Application Publication
(10) Pub. No.: US 2009/0132712 A1
(43) Pub. Date: May 21, 2009

(54) METHOD AND SYSTEM FOR SESSION MOBILITY BETWEEN END USER COMMUNICATION DEVICES

(75) Inventors: Sethuramalingam P, Bangalore (IN); Glen P. Goffin, Dublin, PA (US); Suresh Kumar Chintada, Bangalore (IN)

Correspondence Address: Motorola, Inc.;Law Department, 1303 East Algonquin Road, 3rd Floor, Schaumburg, IL, 60196, US

(73) Assignee: GENERAL INSTRUMENT CORPORATION, Horsham, PA (US)

(21) Appl. No.: 11/942,265

(22) Filed: Nov. 19, 2007

(51) Int. Cl. G06F 15/16

(52) U.S. Cl. 709/227

(57) ABSTRACT

A method and system for providing session mobility between end user communication devices, such as between session initiation protocol (SIP) devices and universal plug and play (UPnP) devices. The session mobility methods and systems make use of a session manager, which can be part of a bridge coupled between the communication devices involved in a communication session, that allows the session to be moved to another end user communication device. The session manager controls the transfer of communication sessions between the end user communication devices. The session manager also is configured to control and manage the addition of end user communication devices to existing sessions between communication devices. As part of this session mobility between communication devices, the session manager can create a virtual device within the bridge to represent an actual communication device that is communicating with a different communication device in a different domain within the communication session.

### BACKGROUND OF THE INVENTION

1. Field of the Invention

The invention relates to exchanging multimedia content and other digital information between end user communication devices. More particularly, the invention relates to providing communication session mobility between end user communication devices, such as between session initiation protocol (SIP) end user communication devices and universal plug and play (UPnP) end user communication devices.

2. Description of the Related Art

Many end user communication devices, including mobile communication devices, are configured to support a session initiation protocol (SIP), which is an application-layer control (signaling) protocol used for many Voice over Internet Protocol (VoIP) applications and other IP-based multimedia applications. Also, many end user communication devices, including audio-visual (AV) communication devices, are configured to support universal plug and play (UPnP™), which is a set of computer network protocols aimed at providing relatively seamless connection between devices, such as within one or more networks.

Many applications and end user scenarios require or need the ability to stream or otherwise exchange multimedia content between end user communication devices, such as between SIP devices and UPnP devices. Moreover, other end user usage applications and scenarios involve session mobility between end user communication devices, such as between SIP devices and UPnP devices. In general, session mobility refers to the ability to transfer an ongoing communication session from one communication device to another. For example, session mobility between SIP devices and UPnP devices can include the desire to dynamically add either an SIP device or a UPnP device to an existing SIP-UPnP or UPnP-UPnP session, or to move an existing SIP-UPnP or UPnP-UPnP session to another SIP or UPnP device.

More specifically, such session mobility may include the ability to seamlessly move an existing session between a UPnP-AV server and an SIP device to another UPnP-AV renderer device, or to seamlessly move an existing session between an UPnP-AV server and an UPnP-AV renderer device to another SIP device. Also, such session mobility may include seamlessly adding a UPnP-AV renderer device into an existing session between an SIP device and a UPnP-AV server device, or seamlessly adding an SIP device into an existing session between a UPnP-AV server and a UPnP-AV renderer device. Also, such session mobility may include seamlessly adding or moving sessions mediated either by an SIP device or a UPnP control point, such as a remote control unit. A UPnP control point is a network entity (e.g., a first UPnP device) that invokes a second UPnP device's functionality, e.g., by invoking an action on the second UPnP device.

A conventional method exists in which an SIP/UPnP protocol bridge is generated for translating message information between UPnP and SIP devices. The protocol bridge uses the SIP message method with new headers and payload type. However, the method does not involve session mobility between SIP devices and UPnP devices. Also, another conventional method exists that involves transferring a Video-on-Demand (VoD) session between different devices in a home network. However, such method is limited to VoD sessions, and does not provide a relatively general architecture that uses existing protocol support of SIP devices and UPnP devices to provide session mobility between such devices. Also, another conventional method exists that involves forwarding UPnP signaling messages by encapsulating them into an SIP request. The method allows a dual mode SIP/UPnP device to stay in touch with a home network, even when the SIP device is roaming. However, the method focuses on pre-session mobility, i.e., the aspect of mobility prior to any session being established. The method does not involve “in-session mobility” or mobility for sessions that already have been established.

### BRIEF DESCRIPTION OF THE DRAWINGS

FIG. 1 is a block diagram of a communication system including a bridge used for communication sessions between end user communication devices;

FIG. 2 is a block diagram of a system for establishing communication sessions between end user communication devices, including providing session mobility between end user communication devices;

FIG. 3 is a block diagram of a communication device configured for establishing communication sessions between end user communication devices, including providing session mobility between end user communication devices;

FIG. 4 is a block diagram of various communication session mobility scenarios between various end user communication devices, including SIP devices and UPnP devices;

FIG. 5 is another block diagram of various communication session mobility scenarios between various end user communication devices, including SIP devices and UPnP devices;

FIG. 6 is another block diagram of various communication session mobility scenarios between various end user communication devices, including SIP devices and UPnP devices; and

FIG. 7 is a block diagram of a method for providing a communication session between end user communication devices, including providing session mobility between end user communication devices.

### DETAILED DESCRIPTION

In the following description, like reference numerals indicate like components to enhance the understanding of the session mobility methods and systems through the description of the drawings. Also, although specific features, configurations and arrangements are discussed herein below, it should be understood that such specificity is for illustrative purposes only. A person skilled in the relevant art will recognize that other steps, configurations and arrangements are useful without departing from the spirit and scope of the invention.

The methods and systems described herein involve providing session mobility between end user communication devices, such as between SIP devices, which are devices configured to support a session initiation protocol (SIP), and UPnP devices, which are devices configured to support universal plug and play (UPnP). The methods and systems make use of a session manager, which can be part of a bridge coupled between end user communication devices involved in a communication session, that allows the communication session to be moved to another end user communication device. The session manager controls or manages the transfer of communication sessions between the end user communication devices. The session manager also is configured to control and manage the addition of end user communication devices to existing communication sessions between communication devices. As part of this session mobility between communication devices, the session manager can create a virtual device within the bridge to represent an actual communication device that is communicating with a different communication device in a different domain within the communication session.

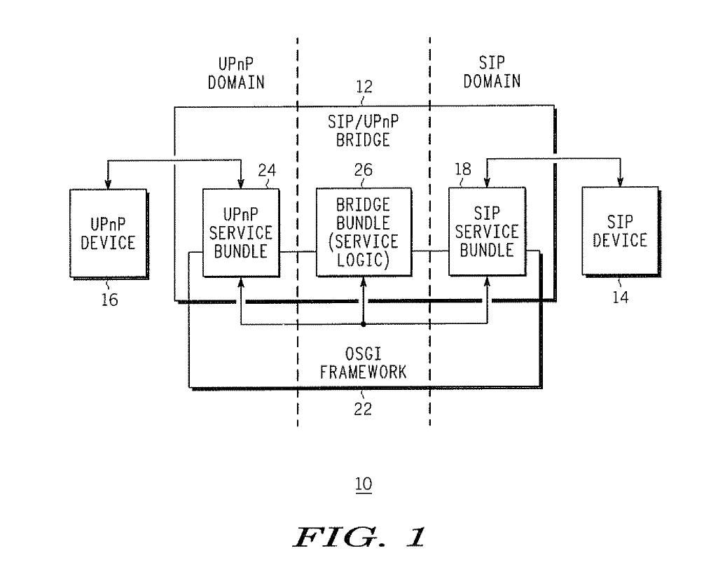

Referring to FIG. 1, shown is a block diagram of a communication system 10 including a bridge 12 used for communication sessions between end user communication devices, e.g., between an end user communication device configured to support a session initiation protocol (SIP), i.e., an SIP device 14, and an end user communication device configured to support universal plug and play (UPnP™), i.e., a UPnP device 16. When used in communication sessions between an SIP device and a UPnP device, the bridge 12 can be referred to as an SIP/UPnP bridge.

In general, the bridge 12 handles the setup and teardown of communication sessions between end user communication devices, e.g., between the SIP device 14 and the UPnP device 16. The bridge 12 can be in any suitable form, e.g., partially or completely configured in the form of hardware circuitry and/or other hardware components within a larger device or group of components, e.g., within one or more of the end user communication devices and/or one or more components coupled thereto and/or therebetween. Alternatively, the bridge 12 can be partially or completely configured in the form of software, e.g., as processing instructions and/or one or more sets of logic or computer code, e.g., contained within one or more of the end user communication devices and/or one or more networks or network component coupled thereto and/or therebetween. In such configuration, the logic or processing instructions typically are stored in a data storage device that is to a processor or controller, which accesses the necessary instructions from the data storage device and executes the instructions or transfers the instructions to the appropriate location.

The SIP device 14 is part of an SIP domain, which also can include one or more SIP service bundles 18 coupled to the SIP device 14. In general, a bundle is one or more applications and/or components for deployment within a service platform or framework, e.g., an OSGi (Open Services Gateway initiative) framework 22. The SIP service bundle 18 includes one or more SIP device or SIP User Agent (SIP-UA) (application) modules that manages virtual SIP devices. As will be discussed in greater detail hereinbelow, a virtual SIP device is a device created to represent another (i.e., non-SIP) end user communication device, e.g., a UPnP device, in the SIP domain. For example, as will be discussed in greater detail hereinbelow, a virtual SIP device can represent, in the SIP domain, a particular service offered by a UPnP device or server.

The UPnP device 16 is part of a UPnP domain, which also can include one or more UPnP service bundles 24 coupled to the UPnP device 16. The UPnP service bundle 24 is one or more UPnP devices that manage physical and virtual UPnP devices. A physical UPnP device is an actual end user communication device configured to support UPnP, as discussed hereinabove. A virtual UPnP device is a device that represents another (i.e., non-UPnP) end user communication device, e.g., an SIP device, in the UPnP domain.

As shown, the SIP service bundle 18 and the UPnP service bundle 24 are part of the bridge 12. The bridge 12 also includes a bridge bundle 26, which is coupled to both the SIP service bundle 18 and the UPnP service bundle 24, e.g., via the OSGi framework 22. The bridge bundle 26 includes service logic, which, inter alia, performs various tasks as part of the interaction between the SIP service bundle 18 and the UPnP service bundle 24. For example, the service logic implements service requests from the SIP domain into an equivalent sequence of services and actions on the UPnP service bundle 24. Also, the service logic implements service requests from the UPnP domain in terms of SIP protocol messages.

In operation, the service logic in the bridge bundle 26 is configured to establish a virtual UPnP device to represent the SIP device 14 in the UPnP domain. As discussed above, the UPnP service bundle 24 manages the virtual UPnP device. Similarly, the service logic in the bridge bundle 26 also is configured to establish a virtual SIP device to represent the UPnP device 16 in the SIP domain. The SIP service bundle 18 manages the virtual SIP device. Through the establishment and management of a virtual end user communication device in the other end user communication device domain, as provided by the bridge 12, bidirectional communication sessions can be created between the end user communication devices, and in a manner that does not change either end user communication device, i.e., the existing capabilities of each end user communication device remains the same.

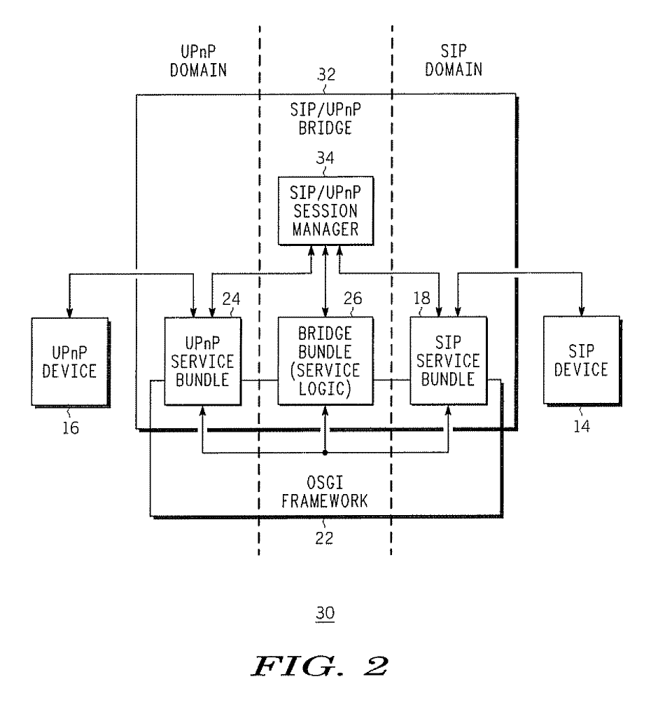

Referring now to FIG. 2, shown is a system 30 for establishing communication sessions between end user communication devices, including providing session mobility or communication session mobility between end user communication devices. The system 30 includes a bridge 32 for communication sessions between end user communication devices, e.g., an SIP/UPnP bridge for communication sessions between the SIP device 14 and the UPnP device 16. However, unlike the bridge 12 in the system 10 in FIG. 1, the bridge 32 in the system 30 includes a session manager 34, which, in addition to handling session setup and session teardown between end user communication devices, also provides session mobility between the end user communication devices. When the bridge 32 is used in communication sessions between the SIP device 14 and the UPnP device 16, the session manager 34 can be referred to as an SIP/UPnP session manager (SUSM).

The bridge 32, including the session manager 34, can be in any suitable form, e.g., partially or completely configured in the form of hardware circuitry and/or other hardware components within a larger device or group of components, e.g., within one or more of the end user communication devices and/or one or more components coupled thereto and/or therebetween. Alternatively, the bridge 32 can be part of an end user communication device facilitating communication sessions and session mobility between other end user communication devices. Also, alternatively, the bridge 32 can be partially or completely configured in the form of software, e.g., as processing instructions and/or one or more sets of logic or computer code, e.g., contained within one or more of the end user communication devices and/or one or more networks or network components coupled thereto and/or therebetween. In such configuration, the logic or processing instructions typically are stored in a data storage device that is to a processor or controller, which accesses the necessary instructions from the data storage device and executes the instructions or transfers the instructions to the appropriate location.

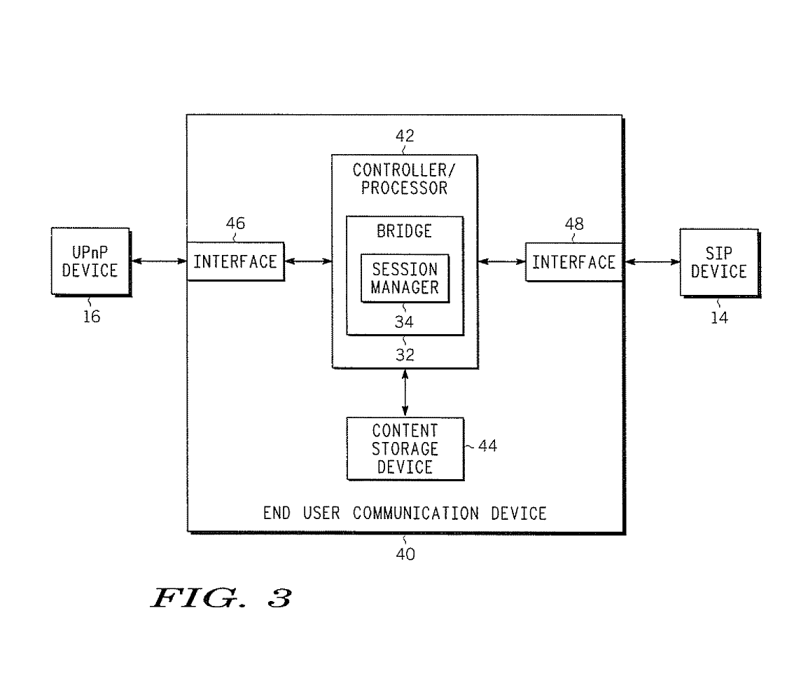

For example, referring now to FIG. 3, with continuing reference to FIG. 2, shown is block diagram of an end user communication device 40 configured for establishing communication sessions between one or more end user communication devices, including providing session mobility between one or more end user communication devices. For example, in the system 30, the end user communication device 40 can be all or a portion of the SIP device 14 and/or the UPnP device 16. Alternatively, the end user communication device 40 can be another (separate) end user communication device, coupled between the SIP device 14 and the UPnP device 16, that establishes communication sessions and provides session mobility between the SIP device 14 and the UPnP device 16, and, as will be discussed in greater detail hereinbelow, between other end user communication devices added to or moved into an existing communication session.

Suitable end user communication devices include any multimedia content receiving, processing, storing and/or viewing device, such as any signal converter or decoder (set-top) box, including set-top boxes with internal and/or external recording capabilities and local and/or remote storage, which often are referred to as personal video recorder (PVR) devices, digital video recorder (DVR) devices and/or digital video server (DVS) devices. Other suitable end user communication devices include residential gateways, home media server systems, digital video disk recorders, computers, televisions with built-in or added-on multimedia content receiving and storing capability, and/or other suitable computing devices or video devices, including internet protocol (IP), satellite and cable digital video recorders, and home area network (HAN) devices and systems. Still other suitable end user communication devices can include mobile and handheld computing devices, such as cellular telephones, smart telephones, personal digital assistants (PDAs), wireless handheld devices, digital cameras, mobile communication devices, music players, laptop personal computers (PCs) and notebook PCs.

The end user communication device 40 includes a controller or processor 42 and a content storage element or device 44 coupled to the controller 42. In general, the controller 42 processes multimedia content and other information received by the end user communication device 40. The controller 42 can include all or a portion of the bridge 32, including the session manager 34, e.g., as shown. Alternatively, all or a portion of the bridge 32 and/or the session manager 34 can be included as part of the content storage device, and accessed as needed by the controller 42. In addition to the end user communication device 40 having the content storage device 44, the controller 42 can include at least one type of memory or memory unit (not shown) and a storage unit or data storage unit coupled to the controller for storing processing instructions and/or information received and/or created by the end user communication device 40.

The end user communication device 40 also can include one or more input and/or output interfaces for receiving and/or transmitting multimedia content and other data and information. For example, the controller 42 and other components in the end user communication device 40 can be coupled between a first interface 46, which, for example, is coupled to the UPnP device 16, and a second interface 48, which, for example, is coupled to the SIP device 14. It should be understood that one or more of the interfaces 46, 48 can be a single input/output interface coupled to the controller 42. Also, it should be understood that one or more of the interfaces 46, 48 can be an interface configured to support more than one SIP device, UPnP device or other suitable end user communication device coupled thereto.

One or more of the controller 42, the content storage device 44 and the interfaces 46, 48 can be comprised partially or completely of any suitable structure or arrangement, e.g., one or more integrated circuits. Also, it should be understood that the end user communication device 40 includes other components, hardware and software (not shown) that are used for the operation of other features and functions of the end user communication device 40 not specifically described herein.

The end user communication device 40 can be partially or completely configured in the form of hardware circuitry and/or other hardware components within a larger device or group of components. Alternatively, the end user communication device 40 can be partially or completely configured in the form of software, e.g., as processing instructions and/or one or more sets of logic or computer code. In such configuration, the logic or processing instructions typically are stored in a data storage device, e.g., the content storage device 44 or other suitable data storage device (not shown). The data storage device typically is coupled to a processor or controller, e.g., the controller 42. The controller accesses the necessary instructions from the data storage device and executes the instructions or transfers the instructions to the appropriate location within the end user communication device 40.

With respect to the content storage device 44, some end user communication devices typically include or have access to a hard drive or other storage element for recording streams of multimedia content, such as video streams broadcast from the multimedia content source. However, the content storage device 44 can be any suitable information storage unit, such as any suitable magnetic storage or optical storage device, including magnetic disk drives, magnetic disks, optical drives, optical disks, and memory devices, including random access memory (RAM) devices and flash memory. Also, although the content storage device 44 is shown within the end user communication device 40, the content storage device 44 can be located external to the end user communication device 40 and suitably coupled thereto.

Within the bridge 32, the session manager 34 is configured to perform a number of tasks related to communication sessions between end user communication devices. For example, with regard to communication sessions between an SIP device and a UPnP device, the session manager 34 can handle requests from either the SIP device or the UPnP device (or UPnP control point, such as a UPnP device remote control unit) to create a communication session between the SIP device and the UPnP device. Similarly, the session manager 34 can handle requests from either the SIP device or the UPnP device to terminate a communication session between the SIP device and the UPnP device.

However, unlike bridges without a session manager, the session manager 34 allows the bridge 32 also to provide session mobility between devices, such as between the SIP device and the UPnP device. For example, the session manager 34 can handle requests from either the SIP device or the UPnP device to move an existing communication session to another SIP device or another UPnP device. Also, the session manager 34 can handle requests from either the SIP device or the UPnP control point to add another SIP device or another UPnP device to an existing communication session. Moreover, the session mobility provided by the session manager 34 can be performed in a manner that re-uses existing SIP and UPnP protocol features supported by the participating SIP and UPnP devices, thus not requiring any modifications, such as software and/or hardware upgrades, to the participating SIP and UPnP devices.

The bridge 32 (and the session manager 34) can be coupled to each end user communication device in any suitable manner, e.g., directly or through one or more networks. The network can be any communication network or network server arrangement suitable for transmitting multimedia content to the end user communication devices. For example, the network can be or include the Internet or an Internet protocol (IP) based network, or other suitable public network. The network also can be or include a computer network, a web-based network or other suitable wired or wireless network or network system, including in-home personal networks.

Described hereinbelow are several end user scenarios that serve as examples to illustrate in greater detail the operation of the bridge 32 and its session manager 34 in providing session mobility, e.g., moving existing communication sessions to additional end user communication devices and adding end user communication devices to existing communication sessions. It should be understood that such scenarios are not exhaustive and that other scenarios are possible in which the bridge 32 and the session manager 34 provide session mobility among end user communication devices.

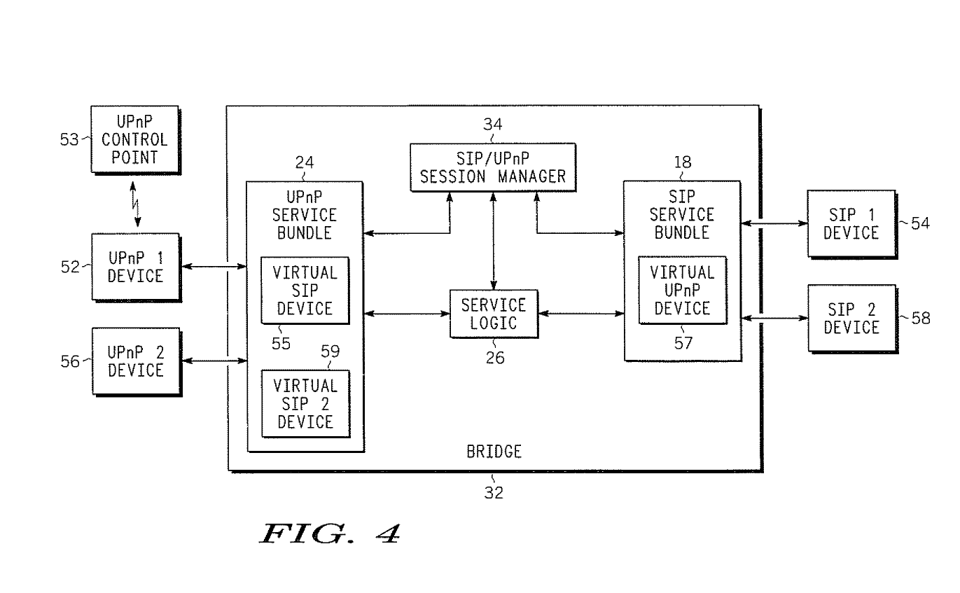

In a first scenario, an end user has established a communication session between a UPnP media server and an SIP telephone, and is transmitting content stored on the UPnP media server, e.g., audio content, to the SIP telephone. The end user then wants to transfer the delivery of the content from the UPnP media server to the SIP telephone to a UPnP media player, using the SIP telephone to mediate the session transfer. That is, the end user wants to move an initial UPnP-SIP session from the SIP device to another UPnP device, resulting in a UPnP1-UPnP2 session, where the UPnP1 device is the UPnP media server and the UPnP2 device is the UPnP media player. Referring now to FIG. 4, this scenario is shown generally as moving an initial communication session between a UPnP1 device 52 (the UPnP media server) and an SIP device 54 (the SIP telephone) to a communication session between the UPnP1 device 52 and a (second) UPnP2 device 56 (the UPnP media player).

Using the session manager 34, the initial UPnP-SIP session is set up by the bridge 32 (and/or the session manager 34) establishing a virtual UPnP device 59 to represent the SIP device (i.e., the SIP telephone) in the UPnP domain. In response to an initial session request (i.e., a conventional SIP INVITE command) from the actual SIP device 54 (i.e., the SIP telephone), the session manager 34 provides the virtual UPnP (v_SIP Device) device 55 with RTP (Real-Time Transfer Protocol) information, which is obtained from the SDP (Session Description Protocol) of the SIP INVITE. Then, the virtual UPnP (v_SIP Device) device 55 establishes a RTSP (Real-Time Streaming Protocol) connection with the UPnP media server device 52. The virtual UPnP device 55 also provides a relay leg of RTP information to the session manager 34. The session manager 34 relays the RTP information to the actual SIP device 54 as part of the session-successful response (200 OK) to the actual SIP device 54. The actual SIP device 54 then sends a final response (ACK) to the session manager 34. The session manager 34 then instructs the virtual UPnP device 55 to start the content RTP stream to the SIP device 54, thus establishing the initial UPnP-SIP communication session between the UPnP media server device 52 and the SIP telephone device 54.

Using the session manager 34, the established UPnP-SIP communication session can be transferred to a second UPnP device 56 (i.e., the UPnP media player), resulting in the UPnP1-UPnP2 session. To effect the session transfer, the end user uses the SIP device 54 to initiate a conventional SIP REFER command, which is detected by the session manager 34. In response to the REFER command, the session manager 34 requests that the virtual UPnP device 55 pause the RTP stream to the actual SIP device 54, i.e., the SIP telephone. The session manager 34 then collects session state information from the virtual UPnP device 55, e.g., the current stream position within the content. The session manager 34 then terminates the SIP session with the actual SIP telephone device 54 and terminates the RTSP session with the UPnP media server device 52. The session manager 34 then sends a session request (SIP INVITE) to the UPnP2 media player device 56. The session request is routed back to the session manager 34 by the virtual UPnP device 55. The session manager 34 then sets up the session with the UPnP media player device 56, e.g., using an AVT (audio video transport) protocol stream. The media transfer from the UPnP media server device 52 to the UPnP media player device 56 then can begin.

Alternatively, in a variation of this first scenario, the session transfer can be mediated using a UPnP control point 53, instead of the SIP telephone device 54. The UPnP control point 53 can be a remote control unit for the UPnP media server device 52, or other suitable UPnP control point. To effect the session transfer to the UPnP media player device 56, the end user initiates the session transfer using the UPnP media server remote control unit 53, e.g., via the unit's user interface.

Initially, the remote control unit 53 pauses the content stream going from the virtual UPnP device 55 to the SIP telephone device 54. The virtual UPnP device 55, in turn, pauses the RTSP connection with the UPnP media server device 52. The remote control unit 53 then obtains session state information from the UPnP media server device 56. The remote control unit 53 then stops the content stream from the virtual UPnP device 55 to the UPnP device 52. The virtual UPnP device 55, in turn, sends a teardown request to the session manager 34. The session manager 34 tears down the session with the virtual SIP device and terminates the session the SIP device 54. The UPnP media player device 56 then sets up an RTSP/RTP media content session with the UPnP media server device 52.

It should be understood that either one or both of the scenarios described hereinabove can occur across two or more networks, depending on the particular system configuration. For example, the UPnP media player may be located in another end user's home network.

In another end user scenario, an end user has established a communication session between a UPnP media server and an SIP mobile telephone, and is transmitting content stored on the UPnP media server, such as audio content, to the SIP mobile telephone. The end user then wants to transfer the delivery the content from the UPnP media server to the SIP mobile telephone to a different or second SIP device, e.g., the end user's SIP cordless telephone, using the first SIP device (the SIP mobile telephone) to mediate the session transfer. In this manner, the initial UPnP-SIP1 session is to be moved to a UPnP-SIP2 session, where the SIP1 device is the end user's SIP telephone and the SIP2 device is the end user's SIP cordless telephone. Referring again to FIG. 4, this particular scenario is shown generally as moving an initial communication session between the UPnP1 device 52 and the SIP device 54 to a communication session between the UPnP1 device 52 and an SIP2 device 58.

The initial UPnP-SIP1 session is set up by the bridge 32 (and/or the session manager 34) in the manner described hereinabove, e.g., with respect to other scenarios. This includes the establishment of a first virtual UPnP device (vSIP1) 55 to represent the SIP1 device 54 in the UPnP domain and a second virtual UPnP device (vSIP2) 59 to represent the SIP2 device 58 in the UPnP domain. Then, using the session manager 34, the established UPnP-SIP1 communication session can be transferred (moved) to the SIP2 device 58, i.e., the SIP cordless telephone, resulting in the UPnP-SIP2 session.

To effect the session transfer, the end user uses the SIP1 mobile telephone device 54 to initiate a conventional SIP REFER command, which is detected by the session manager 34. In response to the REFER command, the session manager 34 requests that the first virtual UPnP device 55 (vSIP1) pause the RTP stream to the actual SIP1 mobile telephone device 54. The session manager 34 then collects session state information from the first virtual UPnP device 55 (vSIP1), e.g., the current stream position within the content. The session manager 34 then terminates the SIP session with the actual SIP1 mobile telephone device 54 and also terminates the RTSP session with the UPnP media server device 52. The session manager 34 then sends a session request (SIP INVITE) to the SIP2 cordless telephone device 58.

Upon receipt of the session-successful response (200 OK) from the SIP2 cordless telephone device 58, the session manager 34 provides the transport information obtained from the session-successful response to the second virtual UPnP device 59 (vSIP2). The second virtual UPnP device 59 (vSIP2) then sets up an RTSP connection with the UPnP media server device 52. The session manager 34 then relays back the RTP information of the UPnP media server device 52 to the SIP2 cordless telephone device 58, via the SIP final response (ACK).

Alternatively, in a variation of this second scenario, the session transfer can be mediated using a UPnP control point. To effect the session transfer to the SIP2 cordless telephone device 58, the end user initiates the session transfer using the UPnP control point 53, such as a UPnP media server remote control unit. The UPnP control point 53 initially requests the first virtual UPnP device 55 (vSIP1) to pause the content stream from the first virtual UPnP device 55 (vSIP1) to the SIP1 mobile telephone device 54. The UPnP control point 53 then obtains session state information from the UPnP media server device 52, and requests that the first virtual UPnP device 55 (vSIP1) terminate the RTSP connection with the UPnP media server device 52. In response to the request, the first virtual UPnP device 55 (vSIP1), in turn, terminates the RTSP session with the UPnP media server device 52, and provides such information to the session manager 34. The session manager 34 terminates the SIP session with the SIP1 mobile telephone device 54. Referring again to FIG. 4, this particular scenario is shown generally as moving an initial communication session between the UPnP1 device 52 and the SIP1 device 54 to a communication session between the UPnP1 device 52 and the SIP2 device 58.

The UPnP control point 53 then sets up transport information and session state information with the second virtual UPnP device 59 (SIP2). The second virtual UPnP device 59 (SIP2) then issues a session setup request to the session manager 34. The remaining steps are the same as in the previous scenario. That is, the session manager 34 sends a session request (SIP INVITE) to the SIP2 cordless telephone device 58 and, upon receipt of the session-successful response (200 OK) from the SIP2 cordless telephone device 58, the session manager 34 provides the transport information obtained from the session-successful response to the second virtual UPnP device 59 (vSIP2). The second virtual UPnP device 59 (vSIP2) then sets up an RTSP connection with the UPnP media server device 52. The session manager 34 then relays back the RTP information of the UPnP media server device 52 to the SIP2 cordless telephone device 58, via the SIP final response (ACK).

In yet another end user scenario, the end user is receiving audio content from a UPnP-enabled device, e.g., a UPnP-enabled music player. The end user then wants to transfer the delivery of the audio content to an SIP device, e.g., an SIP mobile telephone device. Thus, in this scenario, an initial UPnP1-UPnP2 session (i.e., a UPnP media server to UPnP media renderer) is to be moved to a UPnP1-SIP session (i.e., the UPnP media server to the SIP mobile telephone device). In this scenario, the end user is mediating the session transfer using a UPnP control point, i.e., the music player's remote control unit. Referring again to FIG. 4, this particular scenario is shown generally as moving an initial communication session between the UPnP1 device 52 and the UPnP2 device 56 to a communication session between the UPnP1 device 52 and the SIP1 device 54. In this particular scenario, since the initial setup occurs in the UPnP domain between the UPnP media server and the UPnP media player, the session manager 34 does not necessarily establish any virtual UPnP device to represent the SIP device in the UPnP domain, as will become apparent from the session transfer description hereinbelow.

To effect the session transfer to the SIP mobile telephone device 54, the end user initiates the session transfer using the UPnP media server control point 53 (e.g., the UPnP media server remote control unit). The UPnP control point 53 initially requests the UPnP1 media server device 52 to pause the content stream from the UPnP1 media server device 52 to the UPnP2 media player device 56. The UPnP control point 53 then obtains session state information from the UPnP2 media player device 56. The UPnP control point 53 then stops the content stream from the UPnP1 media server device 52 to the UPnP2 media player device 56. In response, the UPnP2 media player device 56 terminates the RTSP connection with the UPnP1 media server device 52.

The UPnP control point 53 then provides transport information and session state information with the UPnP media player device 56, and then issues a session setup request to the session manager 34. The session manager 34 then sends a session request (SIP INVITE) to the SIP mobile telephone device 54 and, upon receipt of the session-successful response (200 OK) from the SIP mobile telephone device 54, the session manager 34 sets up an RTSP connection with the UPnP1 media server device 52. The session manager 34 then relays back the RTP information of the UPnP1 media server device 52 to the SIP mobile telephone device 54, via the SIP final response (ACK). The session manager 34 then instructs the UPnP1 media server device 52 to start the content RTP stream to the SIP mobile telephone device 54, and the media transfer from the UPnP1 media server device 52 to the SIP mobile telephone device 54 then can begin.

In still another end user scenario, the end user is streaming audio content from an SIP mobile telephone device to a first UPnP media player, such as a home UPnP media player. The end user then wants transfer the delivery of the audio content to a second UPnP media player, such as a portable UPnP media player. Thus, in this scenario, an initial SIP-UPnP1 session is to be moved to an SIP-UPnP2 session. In this scenario, the end user is mediating the session transfer using the SIP device. Referring to FIG. 5, this particular scenario is shown generally as moving an initial communication session between the SIP1 device 54 and the UPnP1 device 52 to a communication session between the SIP1 device 54 and the UPnP2 device 56.

To establish the initial SIP-UPnP1 session, the SIP mobile telephone device 54 generates an initial session request (i.e., a conventional SIP INVITE command) to a virtual UPnP device 61 that has been set up by the bridge 32 (and/or the session manager 34) to represent the UPnP1 home media player device 52. In response to the initial session request from the SIP mobile telephone device 54, the session manager 34 also creates a virtual SIP device 63 to represent the SIP mobile telephone device 54 in the UPnP domain. Since the device the SIP mobile telephone device 54 is requesting is a UPnP home media player, i.e., a media renderer, the session manager 34 instantiates or represents the virtual SIP device 63 in a server mode. The session manager 34 also provides the virtual SIP device 63 with RTP information, which was obtained from the SIP INVITE of the SIP mobile telephone device 54.

The session manager 34 then sets up the UPnP1 home media player device 52 with a dummy, relay uniform resource identifier (URI) maintained by the virtual SIP device 63. In general, URIs are used to identify a resource, such as the virtual SIP device 63. The UPnP1 home media player device 52 establishes a RTSP connection with the virtual SIP device 63. The UPnP1 home media player device 52 also provides its RTP information to the virtual SIP device 63.

The virtual SIP device 63 provides the RTP information of the SIP mobile telephone device 54 to the UPnP1 home media player device 52 as part of the RTSP OK reply to the UPnP1 home media player device 52. The UPnP1 home media player device 52 issues an RTSP PLAY command to the virtual SIP device 63. The virtual SIP device 63, in turn, conveys the information to the session manager 34. The session manager 34 relays the RTP information to the SIP mobile telephone device 54, as part of the session-successful response (200 OK) to the SIP mobile telephone device 54. The RTP stream then flows from the SIP mobile telephone device 54 to the UPnP1 home media player device 52.

To effect the session transfer to the UPnP2 portable media player device 56, the end user uses the SIP mobile telephone device 54 to initiate a conventional SIP REFER command, which is detected by the session manager 34. In response to the REFER command, the session manager 34 sends a session request (SIP INVITE) to the virtual UPnP2 device 61, which is representing the UPnP2 portable media player device 56. The INVITE session request gets routed back to the session manager 34, which then requests the UPnP1 home media player device 52 to pause the RTP stream with the virtual SIP device 63. The session manager 34 also executes a call-hold function with the SIP mobile telephone device 54. In general, a call-hold function places the device in an active but non-communicating condition, thus allowing the device to originate and receive additional call connections.

The session manager 34 obtains session state information from the UPnP1 home media player device 52, and requests the UPnP1 home media player device 52 to terminate its RTSP connection with the virtual SIP device 63. The session manager 34 sets up the transport information and session state information with the UPnP2 portable media player device 56. The UPnP2 portable media player device 56 then sets up an RTSP connection with the virtual SIP device 63, providing the RTP information of the UPnP2 portable media player device 56 to the virtual SIP device 63. The virtual SIP device 63 provides the RTP information of the SIP mobile telephone device 54 to the UPnP2 portable media player device 56 as part of the RTSP OK reply to the UPnP2 portable media player device 56. The RTP information of the SIP mobile telephone device 54 originally was obtained from the original SIP INVITE session request.

The virtual SIP device 63 indicates to the session manager 34 the new connection between the virtual SIP device 63 and the UPnP2 portable media player device 56. In response, the session manager 34 removes the call-hold function with the SIP mobile telephone device 54 and also provides an SIP reINVITE session request with the RTP information of the UPnP2 portable media player device 52. The session manager 34 requests the UPnP2 portable media player device 56 to start playing content, and the RTP stream resumes its flow from the SIP mobile telephone device 54, i.e., to the UPnP2 portable media player device 56.

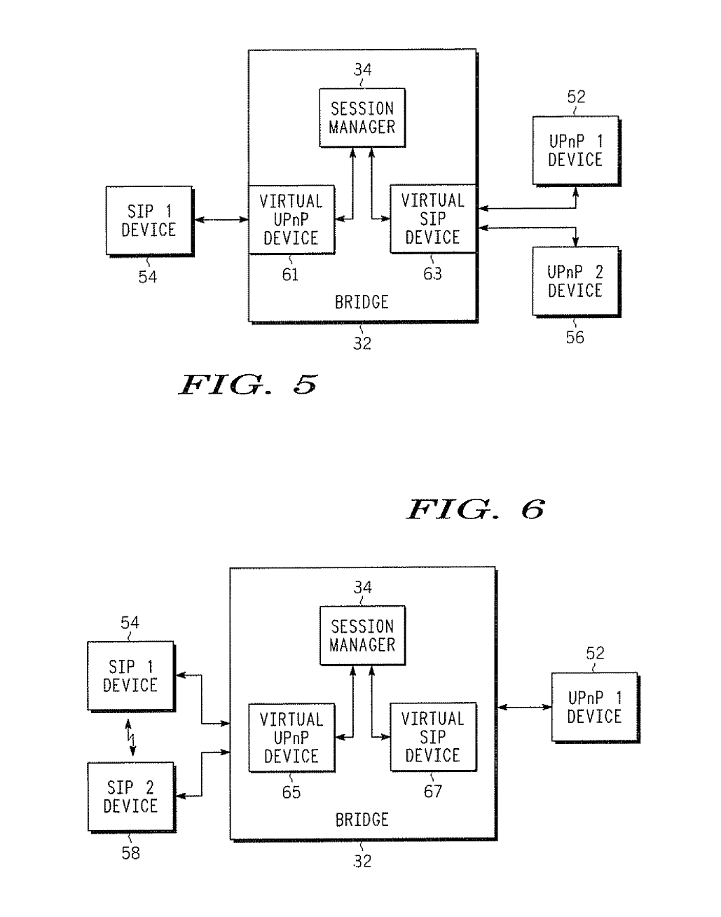

In yet another end user scenario, the end user is streaming media content from a first SIP device, such as the end user's SIP mobile telephone, to a second SIP device, such as the SIP mobile telephone of another. The end user then wants to also stream the media content to a UPnP device, such as the end user's UPnP home media player. Thus, in this scenario, an initial SIP1-SIP2 session is to add a UPnP device to the existing SIP1-SIP2 session. In this scenario, the end user is mediating the session addition using the SIP1 device. Referring to FIG. 6, this particular scenario is shown generally as adding the UPnP1 (home media player) device 52 to an existing communication session between the SIP1 (mobile telephone) device 54 and the SIP2 (mobile telephone) device 58.

In this scenario, the initial SIP1-SIP2 session is assumed to be established already. To effect the addition of the UPnP home media player device 52 to the existing SIP1-SIP2 session, the end user uses the SIP1 mobile telephone device 54 to send a session request (SIP INVITE) to add the UPnP home media player device 52 to the existing SIP1-SIP2 session. The request is directed from the SIP1 mobile telephone device 54 to a virtual UPnP device 65, which has been set up by the bridge 32 (and/or the session manager 34) to represent the UPnP home media player device 52 in the SIP domain. In response to the initial session request from the SIP1 mobile telephone device 54, the session manager 34 also creates a virtual SIP device 67 to represent the SIP1 mobile telephone device 54 in the UPnP domain.

The SIP device 54 sends an INVITE to the session manager 34 (and/or the bridge 32) with the SDP containing the media end point information via the virtual UPnP device 65. The session manager 34 collects RTSP parameters from the virtual SIP device 67. The session manager 34 sends the ACCEPT to the SIP device 54 with the SDP information containing media end point information for the additional leg between the SIP device 54 and the UPnP device 52. The media stream is setup between the SIP device 54 the UPnP device 52.

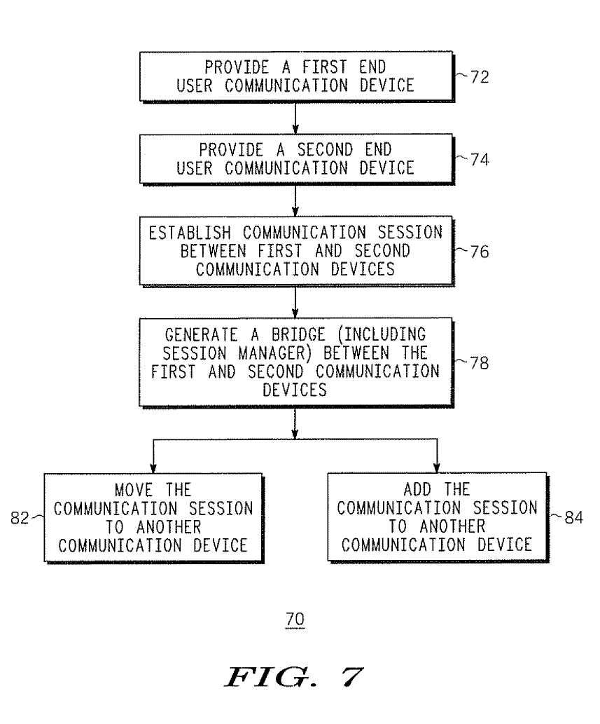

Referring now to FIG. 7, shown is a block diagram of a method 70 for providing communication sessions between end user communication devices, including providing session mobility between end user communication devices. The method 70 includes a step 72 of providing a first end user communication device. As discussed hereinabove, the first end user communication device can be any suitable communication device, such as an end user communication device configured to support a session initiation protocol (SIP), i.e., an SIP device, or an end user communication device configured to support universal plug and play (UPnP), i.e., a UPnP device. The method also includes a step 74 of providing a second end user communication device. As discussed hereinabove, the second end user communication device can be any suitable communication device, such as an SIP end user communication device or a UPnP end user communication device.

The method 70 also includes a step 76 of establishing a communication session between the first end user communication device and the second end user communication device. This initial communication session can be any suitable communication session between end user communication devices, e.g., the transfer of multimedia content or other suitable content between a UPnP device and an SIP device (i.e., a UPnP-SIP session), between two UPnP devices (i.e., a UPnP-UPnP session), between an SIP device and a UPnP device (i.e., an SIP-UPnP session), or between two SIP devices (i.e., an SIP-SIP session). It should be understood that other communication sessions between other end user communication devices are possible.

The method 70 also includes a step 78 of generating a bridge between the first and second end user communication devices. As discussed hereinabove, the bridge 32 handles the setup and teardown (i.e., termination) of communication sessions between end user communication devices, and can be configured in any suitable form, e.g., partially or completely configured in the form of hardware circuitry and/or other hardware components, and/or partially or completely configured in the form of software.

As discussed hereinabove, the bridge 32 includes the session manager 34, which, like the bridge 32, can be configured in any suitable form, e.g., partially or completely hardware and/or software. The session manager 34 is configured to control, manage or otherwise operate the setup and teardown of communication sessions and session connections between communication devices, including virtual devices. The session manager 34 also controls or otherwise manages session mobility between end user communication devices and communication sessions therebetween, e.g., as previously discussed herein.

For example, the method 70 can include a step 82 of moving a communication session between a first end user communication device and a second end user communication device to another end user communication device. That is, the session moving step 82 moves a communication session between the first and second communication devices to a communication session between the first (or second) communication device and another (i.e., third) communication device. As discussed hereinabove, the session moving step 82, and all of the operations involved in performing the session moving step 82, are performed or executed under the direction and control of the session manager 34.

Also, for example, the method 70 can include a step 84 of adding an end user communication device to an existing communication session between end user communication devices, e.g., between a first end user communication device and a second end user communication device. That is, the communication device adding step 84 adds another (i.e., third) communication device to an existing communication session between the first end user communication device and the second end user communication device. As discussed hereinabove, the communication device adding step 84, and all of the operations involved in performing the communication device adding step 84, are performed or executed under the direction and control of the session manager 34.

The session mobility methods and systems described hereinabove can be partially or completely packaged, stored, built or otherwise contained on or within one or more end user communication devices. Alternatively, the session mobility methods and systems described hereinabove can be partially or completely packaged, stored, built or otherwise contained on or within one or more network device or device components, or standalone devices or components, to which one or more of the end user communication devices is or can be coupled.

As discussed hereinabove, the session mobility methods and systems described herein typically do not impose any changes to the SIP or UPnP devices, nor do they typically impact the current operation of the devices in any manner, i.e., they use or re-use existing protocol features and applications. Thus, the methods and systems described hereinabove provide session mobility between end user communication devices that may have relatively limited device capabilities. For example, session mobility can be provided to end user communication devices that may support either SIP or UPnP, but not both protocols. Also, the methods and systems described hereinabove provide session mobility to legacy devices. A legacy SIP device is an SIP device that may only support a relatively limited number of features, e.g., features in accordance with RFC 3261, which is the core SIP specification. A legacy UPnP device is a UPnP device that may only support the features according to one or a limited number of the published UPnP AV specifications, such as the DLNA 1.0 specification.

The method shown in FIG. 7 may be implemented in a general, multi-purpose or single purpose processor. Such a processor will execute instructions, either at the assembly, compiled or machine-level, to perform that process. Those instructions can be written by one of ordinary skill in the art following the description of FIG. 7 and stored or transmitted on a computer readable medium. The instructions may also be created using source code or any other known computer-aided design tool. A computer readable medium may be any medium capable of carrying those instructions and includes random access memory (RAM), dynamic RAM (DRAM), flash memory, read-only memory (ROM), compact disk ROM (CD-ROM), digital video disks (DVDs), magnetic disks or tapes, optical disks or other disks, silicon memory (e.g., removable, non-removable, volatile or non-volatile), packetized or non-packetized wireline or wireless transmission signals.

It will be apparent to those skilled in the art that many changes and substitutions can be made to the session mobility methods and systems herein described without departing from the spirit and scope of the invention as defined by the appended claims and their full scope of equivalents.

1. A method for providing a communication session between a first end user communication device configured to support a session initiation protocol (SIP) and a second end user communication device configured to support at least one protocol from a set of universal plug and play (UPnP) protocols, comprising the steps of:
establishing a communication session between the first end user communication device and the second end user communication device; and
generating a bridge coupled between the first end user communication device and the second end user communication device, wherein the bridge includes a session manager configured in such a way that at least one of
the session manager moves the established communication session between the first end user communication device and the second end user communication device to at least one other end user communication device, and
the session manager adds at least one other end user communication device to the established communication session between the first end user communication device and the second end user communication device.

2. The method as recited in claim 1, wherein the bridge generating step includes coupling an SIP/UPnP bridge between the first end user communication device and the second end user communication device, and wherein the method further comprises at least one of the steps of creating a virtual UPnP device to represent the first end user communication device coupled to the SIP/UPnP bridge, wherein the virtual UPnP device is configured to be accessible from a UPnP domain, and creating a virtual SIP device to represent the second end user communication device coupled to the SIP/UPnP bridge, wherein the virtual SIP device is configured to be accessible from an SIP domain.

3. The method as recited in claim 1, wherein the bridge generating step includes coupling an UPnP/UPnP bridge between the first end user communication device and the second end user communication device, and wherein the method further comprises the step of creating a virtual SIP device to represent the second end user communication device coupled to UPnP/UPnP bridge, wherein the virtual SIP device is configured to be accessible from an SIP domain.

4. The method as recited in claim 1, wherein the bridge generating step includes coupling an SIP/SIP bridge between the first end user communication device and the second end user communication device, and wherein the method further comprises creating a virtual UPnP device to represent the first end user communication device coupled to the SIP/SIP bridge, wherein the virtual UPnP device is configured to be accessible from a UPnP domain.

5. The method as recited in claim 1, wherein the bridge generating step includes generating a software bridge between the first end user communication device and the second end user communication device.

6. The method as recited in claim 1, wherein the bridge generating step generates a transparent bridge in a manner that does not modify the first end user communication device and does not modify the second end user communication device.

7. An end user device for processing multimedia content, comprising:
a controller configured to receive multimedia content in a session initiation protocol (SIP) from a first end user communication device coupled to the end user device and at least one protocol from a set of universal plug and play (UPnP) protocols from a second end user communication device coupled to the end user device; and
a memory element coupled to the controller for storing at least a portion of the multimedia content received by the end user device,
wherein the controller is configured to establish a communication session between the first end user communication device and the second end user communication device, and
wherein the controller is configured to generate a bridge having a session manager between the first end user communication device and the second end user communication device, wherein the session manager is configured in such a way that at least one of
the session manager moves the established communication session between the first end user communication device and the second end user communication device to at least one other end user communication device, and
the session manager adds at least one other end user communication device to the established communication session between the first end user communication device and the second end user communication device.

8. The device as recited in claim 7, wherein the bridge is an SIP/UPnP bridge between the first end user communication device and the second end user communication device, and wherein the session manager is configured to create at least one of a virtual UPnP device to represent the first end user communication device coupled to the SIP/UPnP bridge and a virtual SIP device to represent the second end user communication device coupled to the SIP/UPnP bridge, wherein the virtual UPnP device is configured to be accessible from a UPnP domain and wherein the virtual SIP device is configured to be accessible from an SIP domain.

9. The device as recited in claim 7, wherein the bridge is a UPnP/UPnP bridge between the first end user communication device and the second end user communication device, and wherein the session manager is configured to create a virtual SIP device to represent the second end user communication device coupled to UPnP/UPnP bridge, wherein the virtual UPnP device is configured to be accessible from a UPnP domain.

10. The device as recited in claim 7, wherein the bridge is an SIP/SIP bridge between the first end user communication device and the second end user communication device, and wherein the session manager is configured to create a virtual UPnP device to represent the first end user communication device coupled to the SIP/SIP bridge, wherein the virtual UPnP device is configured to be accessible from a UPnP domain.

11. The device as recited in claim 7, wherein the bridge generating step generates a transparent bridge in a manner that does not modify the first end user communication device and does not modify the second end user communication device.

12. The device as recited in claim 7, wherein the controller is configured to generate a software bridge between the first end user communication device and the second end user communication device.

13. The device as recited in claim 7, wherein the session manager performs at least one of moving the established communication session between the first end user communication device and the second end user communication device to at least one other end user communication device and adding at least one other end user communication device to the established communication session between the first end user communication device and the second end user communication device in such a way that does not modify the first end user communication device and does not modify the second end user communication device.

14. The device as recited in claim 7, wherein the end user device is selected from the group consisting of a signal converter box, a signal decoder box, a digital video recorder, a digital video disk recorder, a personal video recorder device, a home media server, a digital video server, a residential gateway, a video receiver, a computer, a cellular telephone, a smart telephone, a personal digital assistant (PDA), a digital music player, a portable video player, a wireless handheld device, a digital camera, a mobile communication device, a laptop personal computer (PC), a notebook PC and a mobile computing device.

15. A system for providing communication session mobility between at least one first end user communication device configured to support a session initiation protocol (SIP) and at least one second end user communication device configured to support at least one protocol from a set of universal plug and play (UPnP) protocols, comprising:
a session mobility device configured to couple between the first end user communication device and the second end user communication device,
wherein the session mobility device is configured to establish a communication session between the first end user communication device and the second end user communication device, and
wherein the session mobility device is configured to generate a bridge having a session manager between the first end user communication device and the second end user communication device, wherein the session manager is configured in such a way that at least one of
the session manager moves the established communication session between the first end user communication device and the second end user communication device to at least one other end user communication device, and
the session manager adds at least one other end user communication device to the established communication session between the first end user communication device and the second end user communication device.

16. The system as recited in claim 15, wherein the session mobility device is selected from the group consisting of a signal converter box, a signal decoder box, a digital video recorder, a digital video disk recorder, a personal video recorder device, a home media server, a digital video server, a residential gateway, a video receiver, a computer, a cellular telephone, a smart telephone, a personal digital assistant (PDA), a digital music player, a portable video player, a wireless handheld device, a digital camera, a mobile communication device, a laptop personal computer (PC), a notebook PC and a mobile computing device.

17. A computer readable medium storing instructions that, when executed on a programmed processor, carry out a method for providing a communication session between a first end user communication device configured to support a session initiation protocol (SIP) and a second end user communication device configured to support at least one protocol from a set of universal plug and play (UPnP) protocols, comprising:
instructions for establishing a communication session between the first end user communication device and the second end user communication device; and
instructions for generating a bridge coupled between the first end user communication device and the second end user communication device, wherein the bridge includes a session manager configured in such a way that at least one of
the session manager moves the established communication session between the first end user communication device and the second end user communication device to at least one other end user communication device, and
the session manager adds at least one other end user communication device to the established communication session between the first end user communication device and the second end user communication device.

18. The computer readable medium as recited in claim 17, wherein the bridge generating step includes coupling an SIP/UPnP bridge between the first end user communication device and the second end user communication device, and wherein the method further comprises at least one of the steps of creating a virtual UPnP device to represent the first end user communication device coupled to the SIP/UPnP bridge, wherein the virtual UPnP device is configured to be accessible from a UPnP domain, and creating a virtual SIP device to represent the second end user communication device coupled to the SIP/UPnP bridge, wherein the virtual SIP device is configured to be accessible from an SIP domain.

19. The computer readable medium as recited in claim 17, wherein the bridge generating step includes coupling an UPnP/UPnP bridge between the first end user communication device and the second end user communication device, and wherein the method further comprises the step of creating a virtual SIP device to represent the second end user communication device coupled to UPnP/UPnP bridge, wherein the virtual SIP device is configured to be accessible from an SIP domain.

20. The computer readable medium as recited in claim 17, wherein the bridge generating step includes coupling an SIP/SIP bridge between the first end user communication device and the second end user communication device, and wherein the method further comprises creating a virtual UPnP device to represent the first end user communication device coupled to the SIP/SIP bridge, wherein the virtual UPnP device is configured to be accessible from a UPnP domain.

21. The computer readable medium as recited in claim 17, wherein the bridge generating step includes generating a software bridge between the first end user communication device and the second end user communication device.

22. The computer readable medium as recited in claim 17, wherein the bridge generating step generates a transparent bridge in a manner that does not modify the first end user communication device and does not modify the second end user communication device.
